(19) United States
(12) Patent Application Publication
(10) Pub. No.: US 2012/0199249 A1
(43) Pub. Date: Aug. 9, 2012

(54) FLOOR TREATMENT

(75) Inventors: Per Almén, Malmo (SE); Ursula Lombrink, Landskrona (SE); Nils Erik Persson, Sodra Sandby (SE); Gerald Edward Thompson, Monroe, NC (US); John Paul Wiruth, Indian Trail, NC (US)

(73) Assignee: BWE I MALMO AB, Malmo (SE)

(21) Appl. No.: 13/500,216

(22) PCT Filed: Oct. 6, 2010
(86) PCT No.: PCT/SE2010/051077

§ 371 Date: Apr. 4, 2012

(30) Foreign Application Priority Data
Oct. 6, 2009 (SE) 0950734-4

(51) Int. Cl. B27M 1/08; B08B 7/04; B08B 1/00

(52) U.S. Cl. 144/332; 134/4

(57) ABSTRACT

A method for treating a wooden, bamboo and/or cork floor treated with at least one maintenance material and a treated wooden, bamboo and/or cork floor obtained by the method. The method comprises applying a stripping formula on the wooden, bamboo and/or cork floor; allowing the stripping formula to interact with the at least one maintenance material; applying mechanical treatment to release the at least one maintenance material; and removing the at least one maintenance material and the stripping formula.

### TECHNICAL FIELD OF THE INVENTION

The present invention relates to a method for treating a wooden, bamboo and/or cork floor treated with at least one maintenance material as well as a wooden, bamboo and/or cork floor obtained by said method.

### BACKGROUND ART

Floors of natural materials such as wood, bamboo and/or cork need a coating to protect the floor from wear and too maintain an attractive appearance. The coating can be of various types; it may for example be formed from an oil, an alkyd, a urethane modified oil, an industrially applied UV curing acrylate coating, an acid curing system, an aqueous acrylic dispersion, an aqueous polyurethane dispersion or hybrids or mixtures thereof. Aqueous dispersions can be cross-linked by UV-light, by the action of atmospheric oxygen, or by the addition of hardener such as isocyanates, aziridines, carbodiimides, or hydrazides.

A floor of wood, bamboo and/or cork, coated or uncoated, needs regular maintenance to preserve the aesthetic properties. Maintenance is frequently done by the application of e.g. waxes, polishes or aqueous solutions of surface active agents.

Eventually, the attractive appearance of the wooden, bamboo and/or cork floor can not be kept by maintenance actions and a new coating has to be applied. A general prerequisite for a successful recoating is that the floor is clean. Thus, essentially all waxes, polishes, and surfactants that may have accumulated on the surface of the wooden, bamboo and/or cork floor are to be removed. The original coating may or may not be removed.

If the wooden, bamboo and/or cork floor is not prepared properly before recoating, the new coating may not adhere sufficiently. In extreme cases it may be peeled off by a finger nail. Recoating of a floor is costly due to direct costs for material and labour costs but also due to secondary costs caused by the unavailability of the floor during the refurbishing time. It is therefore highly important that a recoating is successful such that there is no need for frequent recoating. In addition, a minimal time for the recoating of the floor is advantageous. If recoating of a floor fails and results in a complaint, the contractor and the client are in a very costly position. The contractor has to do the job all over again and have to pay for new finish. The client will once again be in an awkward position where the room has to be emptied of furniture and is unavailable for living or commercial activities. It is therefore of utmost importance that a recoating of a floor always is successful.

The tale of a wooden, bamboo and/or cork floor is usually unknown and thus neither knowledge of prior maintenance treatments, nor the type of the original coating are known. Furthermore, the wooden, bamboo and/or cork floor may be contaminated by contaminants, such as fats and other products existing in homes, restaurants etc. Proper cleaning is therefore a must. The stripping of a wooden, bamboo and/or cork floor is thus an intricate task.

Historically, many different agents and methods have been used to strip a floor from residues of maintenance materials but none has proven ideal. Solutions with high pH have been used but cause damages to the wood, bamboo and/or cork without securing a good adhesion result. Stripping products based on aggressive organic solvents have been on the market but they do not guarantee a good adhesion result but cause environmental and possible health problems.

Mechanical stripping, e.g. by means of a sanding machine, is occasionally applied but it is a time consuming method where powerful machinery is required. Furthermore, it is impossible to control the process to retain the original coating. A bare wooden, bamboo and/or cork surface is produced that needs a base coat and several layers of top coat. The time for recoating the wooden, bamboo and/or cork floor is therefore highly increased and the lifetime of the wooden, bamboo and/or cork floor is decreased due to waste of wood. In addition, the at least to some extent still useful existing coating is wasted.

Thus, there exists a need for a method that removes the maintenance materials, but at the same time preserves the original coating of a wooden, bamboo and/or cork floor.

### SUMMARY OF THE INVENTION

An object of the present invention is to provide a method, which removes maintenance materials but preserves existing coatings of a wooden, bamboo and/or cork floor. An object of the present invention is to reduce the time for recoating a wooden, bamboo and/or cork floor, in particular compared with sanding. An object of the present invention is to obtain good adhesion between a wooden, bamboo and/or cork floor treated with maintenance materials and a recoating.

These and further objects are achieved by a method for treating a wooden, bamboo and/or cork floor treated with at least one maintenance material, which method comprises applying a stripping formula on the wooden, bamboo and/or cork floor; allowing the stripping formula to interact with the at least one maintenance material; applying mechanical treatment to release the at least one maintenance material; and removing the at least one maintenance material and the stripping formula.

The method of the present invention provides a clean wooden, bamboo and/or cork floor surface with retained existing coating, from a coated and maintenance material treated wooden, bamboo and/or cork floor.

The method of the present invention removes the maintenance materials but principally does not remove the existing coating of the wooden, bamboo and/or cork floor. In addition, the method of the present invention removes contaminants, such as fats and other products existing in homes, restaurants etc. The method of the present invention is much less time consuming than sanding, especially since the need for applying several layers of coating, including a base coating, is avoided. The method according to the present invention is also much more reliable and lenient to the wood, bamboo and/or cork than using aggressive organic solvents. The method of the present invention provides good adhesion of the recoating to the wooden, bamboo and/or cork floor. The method according to the present invention may be carried out without knowledge of the history of the wooden, bamboo and/or cork floor, i.e. which treatments that have been applied to the wooden, bamboo and/or cork floor in the past. The method of the invention enables a good adhesion of the recoating to the wooden, bamboo and/or cork floor without knowing the history of the wooden, bamboo and/or cork floor. The method of the present invention provides a treatment that results in a good adhesion of the recoating to the wooden, bamboo and/or cork floor without adapting the treatment to the condition or the history of the wooden, bamboo and/or cork floor. In particular, an operator conducting the treatment does not have to adapt the treatment to the condition or the history of the wooden, bamboo and/or cork floor. The method according to the present invention enables recoating of a wooden, bamboo and/or cork floor by any wooden, bamboo and/or cork floor coating.

The present invention also relates to a treated wooden, bamboo and/or cork floor obtained according to the above method.

### DETAILED DESCRIPTION OF THE INVENTION

As used herein, a wooden, bamboo and/or cork floor means any floor comprising wood, bamboo and/or cork, such as a solid wooden, bamboo and/or cork floor, a parquet floor of wood, bamboo and/or cork, a floor laminated with wood, bamboo and/or cork, a floor made of particulated wood, bamboo and/or cork or a floor made of pulverized wood, bamboo and/or cork. As used herein, wood means any kind of wood. Thus, wood includes but are not limited to oak, beech, maple, spruce, pine, alder, elm, ash, aspen, birch, juniper, fir, redwood, lime, larch, mahogany, teak, walnut and cedar.

A wooden, bamboo and/or cork floor may be a bare wooden, bamboo and/or cork floor, a coated wooden, bamboo and/or cork floor, a wooden, bamboo and/or cork floor treated with maintenance materials or a contaminated wooden, bamboo and/or cork floor, such as a wooden, bamboo and/or cork floor contaminated with contaminants such as fats and other products existing in homes, restaurants etc.

In one embodiment of the present invention, the wooden, bamboo and/or cork floor is a wooden floor.

In one embodiment of the present invention, the wooden, bamboo and/or cork floor is coated by an existing coating.

In one embodiment of the present invention, the existing coating is substantially preserved after removing the at least one maintenance material and the stripping formula.

As used herein, a coating means a layer applied to a floor intended to give a substantially permanent protection to the floor. A coating may typically be a lacquer or a varnish. A coating may typically be formed from an oil, an alkyd, a urethane modified oil, an industrially applied UV curing acrylate coating, an acid curing system, an aqueous acrylic dispersion, an aqueous polyurethane dispersion or hybrids thereof. As used herein, the verb coat means applying a coating to a floor.

In one embodiment, the at least one maintenance material is selected from the group consisting of waxes, hard wax oil, polishes, detergents such as dishwasher detergents and washing detergents, soaps, soft soaps, scouring agents, cleaning agents and/or aqueous solutions of surface active agents; or any combination or mixture thereof. In one embodiment, the at least one maintenance material is at least one wax and/or at least one polish.

As used herein, a maintenance material means an agent applied to a coated floor in order to preserve the properties of the floor, such as the aesthetic properties. A maintenance material may typically be a wax, a hard wax oil, a polish, a detergent such as a dishwasher detergent and/or a washing detergent, a soap, a soft soap, a scouring agent, a cleaning agent and/or an aqueous solution of surface active agents. A treatment of a wooden, bamboo and/or cork floor with a maintenance material has often been made by applying a solution, typically an aqueous solution, of the maintenance material on the wooden, bamboo and/or cork floor.

In many cases, a wooden, bamboo and/or cork floor has been treated with several maintenance materials and/or treated several times with the same kind of maintenance material. There also exist cases when a wooden, bamboo and/or cork floor only has been treated with a maintenance material once. The method of the invention is suitable in all these cases. Thus, the method of the present invention is suitable both for wooden, bamboo and/or cork floor that have been treated with a maintenance material once and with maintenance materials several times. It is not necessary to know the history of the wooden, bamboo and/or cork floor to be treated according to the method of the invention, e.g. if said floor is treated one or several times with a maintenance material, in order to carry out the method according to the invention and to achieve a good adhesion result. Since it not is necessary to know the history of the wooden, bamboo and/or cork floor to be treated according to the method of the present invention also wooden, bamboo and/or cork floors not treated with a maintenance material may benefit from a treatment according to the method of the present invention. In case of a wooden, bamboo and/or cork floor not treated with a maintenance material but contaminated with contaminants, such as fats, the use of the method according to the invention will remove the contaminants without removing an existing coating and thus achieve good adhesion of a recoating to the wooden, bamboo and/or cork floor. If treating a wooden, bamboo and/or cork floor not treated with a maintenance material but contaminated with contaminants according to the method of the invention, the method will comprise applying a stripping formula on the wooden, bamboo and/or cork floor, allowing the stripping formula to interact with the contaminants, applying mechanical treatment to release the contaminants and removing the contaminants and the stripping formula.

In one embodiment of the present invention, the stripping formula is a liquid or a slurry such as a paste. In one embodiment of the present invention, the stripping formula is a liquid. Preferably, the liquid is a viscous liquid. By a viscous liquid is meant a liquid having a viscosity higher than the viscosity of water.

In one embodiment of the present invention, the stripping formula comprises at least one of the following: a surface active agent, a swelling agent, a grinding agent and a carrier.

In one embodiment of the present invention, the stripping formula comprises at least two of the following: a surface active agent, a swelling agent, a grinding agent and a carrier.

In one embodiment of the present invention, the stripping formula comprises at least three of the following: a surface active agent, a swelling agent, a grinding agent and a carrier.

In one embodiment of the present invention, the stripping formula comprises a surface active agent, a swelling agent, a grinding agent and a carrier.

In one embodiment of the present invention, the stripping formula further comprises at least one additive.

As used herein, “at least one” may mean one. As used herein, “at least one” may also mean two, three, four, five etc.

In one embodiment of the present invention, the stripping formula consists of a surface active agent, a swelling agent, a grinding agent and a carrier.

In one embodiment, the stripping formula consists of a surface active agent, a swelling agent, a grinding agent, a carrier and at least one additive.

In one embodiment of the invention, the surface active agent is selected from the group consisting of nonionic surface active agents such as monoalcohol ethoxylates such as monoalcohol monopropoxylate ethoxylate and fatty alcohol ethoxylates, Guerbet alcohol ethoxylates, fatty alcohol propoxylates, alkylphenol ethoxylates, copolymers of ethylene oxide and propylene oxide such as, and alkyl(poly)glucosides; anionic surface active agents such as soaps, sulfonated derivatives and phosphated derivatives; cationic surface active agents; and amphoteric surface active agents; or any combination or mixture thereof. In some embodiments, the surface active agent is a nonionic surface active agent, such as monoalcohol monopropoxylate ethoxylate.

In one embodiment of the invention, the swelling agent is selected from the group consisting of alcohols such as butanol, benzyl alcohol, propylene glycol, diethylene glycol, dipropylene glycol, hexylene glycol, glycerol; esters such as butyl acetate; dibasic esters such as dimethyl succinate, dimethyl glutarate, dimethyl adipate, diisopropyl succinate, and diisopropyl adipate; ketones such as isobutyl methyl ketone; ethers such as alkoxylated alcohols such as methoxyethanol, ethoxyethanol, butoxyethanol, phenoxyethanol, phenoxypropanol, diethyleneglycol monomethyl ether, propylene glycol monomethyl ether, dipropylene glycol monomethyl ether, tripropylene glycol monomethyl ether, dipropylene glycol monobutyl ether, dipropylene glycol monopropyl ether, and dipropyleneglycol dimethyl ether; heterocyclics such as N-methyl-2-pyrrolidone, N-ethyl-2-pyrrolidone, tetrahydrofurane, propylene carbonate and butylene carbonate; hydrocarbons such as terpenes; dimethyl-formamide and dimethylsulfoxide; or any combination or mixture thereof. In some embodiments, the swelling agent is an ether compound such as propyleneglycol monomethyl ether, dipropylene glycol monomethyl ether, dipropyleneglycol dimethyl ether, and/or phenoxyethanol.

In one embodiment of the invention, the grinding agent is selected from the group consisting of organic grinding agents, such as hard polymer particles, such as polystyrene and poly(methyl methacrylate); amino resins; grinding agents of natural origin, such as grinding agents derived from nut shell; and inorganic grinding agents, such as aluminium oxide, silica, carborundum, boronitride, zirconium carbide, diamond, and quarts mineral; or any combination or mixture thereof. In some embodiments, the grinding agent is aluminium oxide and/or quarts mineral.

In one embodiment of the present invention, the grinding agent is of particulate shape and the particle size may be 20-400 mesh, such as 60-320 mesh.

In one embodiment of the invention, the carrier is water.

In one embodiment of the present invention, the at least one additive is a stabilizing agent, a complexing agent, a pH regulating agent, a colorant, a perfume and/or a preservative.

In one embodiment of the invention, the stabilizing agent is selected from the group consisting of clays, cellulose derivatives, polyacrylate compounds, polyurethane compounds, fumed mixed oxides, and fumed silica, or any combination or mixture thereof. In some embodiments, the stabilizing agent is clay.

In one embodiment of the invention, the complexing agent is selected from the group consisting of EDTA, nitrilotriacetic acid, N,N-bis(carboxy-methyl)-β-alanine, and Trilones (A-D, M , and P) or any combination or mixture thereof. In some embodiments, the complexing agent is N,N-bis(carboxy-methyl)-β-alanine.

In one embodiment of the invention, the pH regulating agent is selected from the group consisting of sodium hydroxide, disodium metasilicate, amines such as triethanolamine, ammonia, and acids such as phosphoric, citric or lactic acid, or any combination or mixture thereof. In some embodiments, the pH regulating agent is sodium hydroxide and/or phosphoric acid.

In one embodiment of the invention, the stripping formula further comprises an opening time regulator.

In one embodiment of the invention, the opening time regulator is selected from the group consisting of fatty acids, such as stearic acid, pelargonic acid, dodecanoic acid, tetradecanoic acid, hexadecanoic acid, octadecanoic acid, docosanoic acid, eicosanoic acid, oleic acid, 2-ethylhexanoic acid, adipic acid, and azelaic acid. In some embodiments, the opening time regulator is stearic acid.

In one embodiment of the invention, the stripping formula is applied evenly on the floor to be undressed and recoated.

As used herein, a recoating means a renewed coating, i.e. a new layer of coating applied to a floor. A recoating may be applied several times to a floor. Normally, the recoating is applied when the existing coating is worn or for other reasons must be renewed. As used herein, the verb recoat means applying a recoating to a floor.

In one embodiment of the invention, the stripping formula is applied on the wooden, bamboo and/or cork floor by an applicator, such as a roller, a brush, a mop or a pad.

In one embodiment of the invention, the stripping formula is applied in an amount of 0.3-4 liter per 10 m² wooden, bamboo and/or cork floor, such as 0.5-2 liter per 10 m² wooden, bamboo and/or cork floor.

In one embodiment of the invention, the stripping formula is allowed to interact with the at least one maintenance material before applying the mechanical treatment.

In one embodiment of the invention, the stripping formula is allowed to interact with the at least one maintenance material for 0.08-60 minutes, such as for 1-30 minutes, such as for 3-5 minutes, before applying the mechanical treatment.

In one embodiment of the invention, the mechanical treatment is applied for 2-20 minutes per 10 m² wooden, bamboo and/or cork floor, such as for 3-15 minutes per 10 m² wooden, bamboo and/or cork floor, such as for 4-10 minutes per 10 m² wooden, bamboo and/or cork floor.

The mechanical treatment of the floor may be carried out by any suitable means. Suitable means may be a machine operating substantially horizontally or substantially vertical. The machine may oscillate. Alternatively, the mechanical treatment may be carried out manually.

In one embodiment of the invention, the mechanical treatment is buffing.

In one embodiment of the invention, the mechanical treatment is carried out by means of a buffing machine.

In one embodiment of the invention, the buffing machine is equipped with at least one abrasive pad or Bona Sanding Screen P60. The buffing machine may be a Bona Buffer.

In one embodiment of the invention, the pad of the buffing machine is changed after mechanical treatment of 4-40 m² wooden, bamboo and/or cork floor, such as after 5-20 m² wooden, bamboo and/or cork floor, such as after 8-12 m² wooden, bamboo and/or cork floor.

The at least one maintenance material and the stripping formula may be removed by means of a squeegee or by sucking or soaking up the at least one maintenance material and the stripping formula.

In one embodiment of the invention, applying a stripping formula on the wooden, bamboo and/or cork floor; allowing the stripping formula to interact with the at least one maintenance material; and applying mechanical treatment to release the at least one maintenance material are repeated at least one time, preferably only one time. Preferably, also the removal of the at least one maintenance material and the stripping formula is repeated together with the preceding steps. The second mechanical treatment of the floor may preferably be applied substantially perpendicular to the first mechanical treatment.

The method may also be performed by an autoscrubber which is used to apply a stripping formula on the floor, apply mechanical treatment to release the at least one maintenance material and remove the at least one maintenance material and the stripping formula.

Naturally, allowing the stripping formula to interact with the at least one maintenance material is to be carried out after applying a stripping formula on the wooden, bamboo and/or cork floor. Also, applying mechanical treatment to release the at least one maintenance material is to be carried out after allowing the stripping formula to interact with the at least one maintenance material. In addition, removing the at least one maintenance material and the stripping formula is to be carried out after applying mechanical treatment to release the at least one maintenance material. However, a later step does not have to be carried out directly after an earlier step. For example, additional steps may be carried out between the steps and one or several of the steps may be repeated, either alone or in combination.

In some embodiments of the invention, the method further comprises cleaning the wooden, bamboo and/or cork floor before and/or after the at least one maintenance material and the stripping formula are removed. In some embodiments, the cleaning of the wooden, bamboo and/or cork floor is performed after the at least one maintenance material and the stripping formula are removed. This further improves the adhesion between the wooden, bamboo and/or cork floor and the recoating with which the wooden, bamboo and/or cork floor is intended to be recoated. In some embodiments of the invention, the cleaning of the wooden, bamboo and/or cork floor is performed before the stripping formula is applied on the wooden, bamboo and/or cork floor. This implies that not unnecessary dust and/or contaminants are present on the wooden, bamboo and/or cork floor when applying the stripping formula, which improves the efficiency of the stripping formula and the mechanical treatment.

Preferably, after the removal of the at least one maintenance material and the stripping formula, the wooden, bamboo and/or cork floor is wiped with a wet cloth or sponge to secure a perfectly clean surface. This further improves the adhesion between the wooden, bamboo and/or cork floor and the recoating with which the wooden, bamboo and/or cork floor is intended to be recoated.

In one embodiment of the invention, the method further comprises recoating of the wooden, bamboo and/or cork floor. The recoating is to be carried out after the removal of the at least one maintenance material and the stripping formula. In some embodiments, the wooden, bamboo and/or cork floor is cleaned before recoating of the wooden, bamboo and/or cork floor.

The method of the present invention may also be used on floors made of other materials than wood, bamboo and/or cork and still achieve good adhesion between the floor and a recoating. Such materials may be stone materials such as marble and granite, ceramic materials such as clinker, concrete, glass and plastics.

One embodiment of the present invention relates to a method for treating a wooden, bamboo and/or cork floor, wherein the wooden, bamboo and/or cork floor is coated by an existing coating and is treated with at least one maintenance material, which method comprises applying a stripping formula on the wooden, bamboo and/or cork floor, wherein the stripping formula is a liquid or a slurry such as a paste comprising a surface active agent, a swelling agent, a grinding agent, a carrier and at least one additive, wherein the surface active agent is selected from the group consisting of nonionic surface active agents such as monoalcohol ethoxylates such as monoalcohol monopropoxylate ethoxylate and fatty alcohol ethoxylates, Guerbet alcohol ethoxylates, fatty alcohol propoxylates, alkylphenol ethoxylates, copolymers of ethylene oxide and propylene oxide, and alkyl(poly)glucoside; anionic surface active agents such as a soaps, sulfonated derivatives and phosphated derivatives; cationic surface active agents; and amphoteric surface active agents; or any combination or mixture thereof; the swelling agent is selected from the group consisting of alcohols such as butanol, benzyl alcohol, propylene glycol, diethylene glycol, dipropylene glycol, hexylene glycol, glycerol; esters such as butyl acetate; dibasic esters such as dimethyl succinate, dimethyl glutarate, dimethyl adipate, diisopropyl succinate, and diisopropyl adipate; ketones such as isobutyl methyl ketone; ethers such as alkoxylated alcohols such as methoxyethanol, ethoxyethanol, butoxyethanol, phenoxyethanol, phenoxypropanol, diethyleneglycol monomethyl ether, propylene glycol monomethyl ether, dipropylene glycol monomethyl ether, tripropylene glycol monomethyl ether, dipropylene glycol monobutyl ether, dipropylene glycol monopropyl ether, and dipropyleneglycol dimethyl ether; heterocyclics such as N-methyl-2-pyrrolidone, N-ethyl-2-pyrrolidone, tetrahydrofurane, propylene carbonate and butylene carbonate; hydrocarbons such as terpenes; dimethylformamide and dimethylsulfoxide; or any combination or mixture thereof; the grinding agent is selected from the group consisting of organic grinding agents, such as hard polymer particles, such as polystyrene and poly(methyl methacrylate); amino resins; grinding agents of natural origin, such as grinding agents derived from nut shell; and inorganic grinding agents, such as aluminium oxide, silica, carborundum, boronitride, zirconium carbide, diamond, and quarts mineral; or any combination or mixture thereof; the carrier is water; and the at least one additive is a stabilizing agent, a complexing agent, a pH regulating agent, a colorant, a perfume and/or a preservative;

allowing the stripping formula to interact with the at least one maintenance material, wherein the stripping formula is allowed to interact with the at least one maintenance material for 0.08-60 minutes, such as for 1-30 minutes, such as for 3-5 minutes;

applying mechanical treatment to release the at least one maintenance material;

removing the at least one maintenance material and the stripping formula;

cleaning the wooden, bamboo and/or cork floor;

recoating of the wooden, bamboo and/or cork floor; wherein the at least one maintenance material is selected from the group consisting of waxes, polishes, detergents such as dishwasher detergents and washing detergents, soaps, soft soaps, scouring agents, cleaning agents and/or aqueous solutions of surface active agents; or any combination or mixture thereof; and wherein the existing coating is substantially preserved after removing the at least one maintenance material and the stripping formula.

The interaction of the stripping formula with the at least one maintenance material causes the at least one maintenance material to swell and loose its mechanical strength.

The interacting of the stripping formula with the at least one maintenance material and the mechanical treatment of the wooden, bamboo and/or cork floor disintegrates and suspends or emulsifies the at least one maintenance material, which thus easily can be collected and removed together with the stripping formula.

The disintegrated and suspended or emulsified at least one maintenance material forms together with the stripping formula a debris. This debris may easily be collected and removed from the wooden, bamboo and/or cork floor.

The stripping formula and/or the mechanical treatment may also detach contaminants possibly existing on the wooden, bamboo and/or cork floor, such as fats and other products existing in homes, restaurants etc. Thus, the debris may also contain contaminants, such as fats and other products existing in homes, restaurants etc.

The surface active agent of the invention reduces the surface tension and prevents debris comprising at least one maintenance material from readhering to the wooden, bamboo and/or cork floor.

The swelling agent of the invention softens layers of existing maintenance material.

The grinding agent of the invention mechanically detaches the debris comprising at least one maintenance material from the wooden, bamboo and/or cork floor.

The stabilizing agent of the invention prevents sedimentation of the grinding agent and gives the stripping formula a creamy consistency. The stabilizing agent may be a thickening agent.

The complexing agent assists the removal of metal contaminants and reduces the formulas sensitivity to hard water.

The pH regulating agent regulates the pH to produce a user friendly product and to keep the natural color of the wood.

The colorant provides an aesthetic appearance and may make it easier to determine to which parts of a wooden, bamboo and/or cork floor the stripping formula has been applied.

The perfume provides an attractive scent.

The preservative prevents growth of microbial organisms such as bacteria and mould during storage of the stripping formula.

The open time regulator retards the evaporation of water from the stripping formula and thus increases the time during which the stripping formula may interact with the wooden, bamboo and/or cork floor.

Some of the ingredients of the stripping formula that have been exemplified above may have further effects on the stripping formula than indicated from the type of ingredient. For example, in addition to being an opening time regulator, stearic acid also affects the pH of the stripping formula.

Embodiments disclosed herein may also be combined and even if certain embodiments are not disclosed in direct connection a skilled person would realize the possible combination thereof.

### EXAMPLES

### Example 1

### A Stripping Formula of the Invention

| Type of | | | |
|---|---|---|---|
| ingredient | Chemical description | Trade name | %-age |
| Carrier phase | water | | 77.9 |
| Surface active | C10 Oxo alcohol | Lutensol ON 70 | 1.0 |
| agent | ethoxylate 7EO | | |
| Swelling agent | N-ethyl-2-pyrrolidine | NEP | 2.0 |
| Grinding agent | aluminum oxide | Alodur SPWL P240 | 15 |
| Stabilizing | polyurethane | Acrysol RM 825 | 2.5 |
| agent | thickener | | |
| Complexing | tetrasodium | EDTA | 0.25 |
| agent | ethylenediamine- | | |
| | tetraacetate | | |
| pH regulating | ammonia (24%) | | 0.20 |
| agent | | | |
| Colorant | phthalocyanine | Luconyl Blau | 0.01 |
| | type | | |
| Perfume | | Belle-Air | 0.01 |
| | | Fragrance | |
| Preservative | | Nipacide GSF | 0.10 |
| Opening time | Stearic acid | Prifac 2918 | 1.0 |
| regulator | | | |

### Example 2

### A Stripping Formula of the Invention

| Type of | | | |
|---|---|---|---|
| ingredient | Chemical description | Trade name | %-age |
| Carrier phase | water | | 82.9 |
| Surface active | C13C15 Oxo alcohol | Lutensol | 1.0/0.25 |
| agent | ethoxylate/ | AO109/Berol | |
| | sodium dodecyl | 452 AN | |
| | sulfonate | Surfactants | |
| Swelling agent | Dipropylene | DMM/glycerol | 2.0/1.0 |
| | glycol dimethyl | | |
| | ether/glycerol | | |
| Grinding agent | silicon carbide | SC grit 240 | 10.0 |
| Stabilizing | polyurethane | Acrysol RM 825 | 2.5 |
| agent | thickener | | |
| Complexing | tetrasodium | EDTA | 0.25 |
| agent | ethylenediamine- | | |
| | tetraacetate | | |
| pH regulating | citric acid | citric acid | 0.1 |
| agent | | | |
| Colorant | phthalocyanine | Luconyl Blau | 0.01 |
| | type | | |
| Perfume | | Bell-Air | 0.01 |
| | | Fragrance | |
| Preservative | | Nipacide GSF | 0.10 |

### Example 3

### A Stripping Formula of the Invention

| Type of | | | |
|---|---|---|---|
| ingredient | Chemical description | Trade name | %-age |
| Carrier phase | water | | 83.6 |
| Surface active | C13C15 Oxo alcohol | Lutensol | 1.0/0.25 |
| agent | ethoxylate/ | AO109/ | |
| | dodecylbenzene- | DBSA | |
| | sulfonic acid | | |
| Swelling agent | dimethylsulfoxide | DMSO | 2.0 |
| Grinding agent | silicon carbide | SC grit 240 | 10.0 |
| Stabilizing | PU thickener | Acrysol RM825 | 2.5 |
| agent | | | |
| Complexing | nitrilotriacetic | Trilon AS | 0.25 |
| agent | acid | | |
| pH regulating | triethanolamine/ | TEA/NaOH | 0.04/0.05 |
| agent | sodium hydroxide | | |
| Colorant | phthalocyanine | Luconyl Blau | 0.01 |
| | pigment | | |
| Perfume | | Bell-Air | 0.01 |
| | | Fragrance | |
| Preservative | | Nipacid GSF | 0.10 |

### Example 4

### A Stripping Formula of the Invention

| Type of | | | |
|---|---|---|---|
| ingredient | Chemical description | Trade name | %-age |
| Carrier phase | water | | 83.6 |
| Surface active | C13C15 Oxo alcohol | Lutensol AO109 | 1.0 |
| agent | ethoxylate | | |
| Swelling agent | N-ethyl-2-pyrrolidone | NEP | 2.0 |
| Grinding agent | aluminium oxide | Alodur SPWL P240 | 10.0 |
| Stabilizing | — | — | — |
| agent | | | |
| Complexing | — | — | — |
| agent | | | |
| pH regulating | — | — | — |
| agent | | | |
| Colorant | — | — | — |
| Perfume | — | — | — |
| Preservative | — | — | — |

### Example 5

### Treating a Wooden Floor According to the Method of the Invention

A room of 12 m², with a wooden floor coated with an industrially applied UV-cured finish, that had been used as an office for more than 2 years was to be refurbished. The base mouldings were protected by applying masking tape. The stripping formula according to example 1 (0.75 kg) was spread on half the floor using a roller. It was allowed to act on the floor for approximately 5 min. Thereafter, the floor was treated mechanically for approx. 6 min using a low speed buffer with a grinding pad. The debris was removed using a squeegee and a dustpan. The floor is then sprayed with a cleaner (Bona Cleaner) and wiped using a micro fiber pad. The micro fiber pad was replaced for a new, after each 4 m². The procedure was repeated, with a small overlap, on the untreated half of the floor. The procedure was repeated twice on each half of the floor and after a final cleaning with a damp mop, the floor was ready for coating.

### Example 6

### Coating of a Floor Treated According to the Method of the Invention

The floor treated according to example 5 was coated with Bona Traffic according to instructions of the manufacturer. After 1 week, the adhesion of the coating was tested using a coin scratch test. The coated floor was scratched with the coin and the coating did not detach from the substrate. The adhesion was also assessed using the cross-cut test according to EN ISO 2409:1994. The finish on the floor treated according to the invention was classified with FIG. 5, which is the maximum result of the cross-cut test. This proves the efficiency of the preparation procedure.

### Example 7

### Treating a Wooden Floor According to the Method of the Invention and Coating Thereof

A laboratory test area of 1.5×1.5 m made of new Boen 100% solids acrylate industrially coated and cured wooden tiles was treated with 2.5 kg of the stripping formula of example 4 spread evenly over the surface. It was allowed to act on the test area for approximately 10 min. Thereafter, the area was treated mechanically for approx. 4 min using low speed buffer with a grinding pad. The debris was removed and the floor sprayed with a cleaner (Bona Cleaner) and wiped with a micro fiber pad. The spaying and wiping procedures was repeated 3 times, and after a final cleaning with a damp mop, the floor was coated using Bona Traffic following instructions of the manufacturer. After 1 week, the coating passed the coin test demonstrating, in general the high performance of the invention and, specifically, that base formula of example 4 is functional.

### Example 8

### Comparative, Coating of a Floor Treated using a Standard Stripper

A floor as in example 5, but treated with Jontek Prostrip according to instructions of the manufacturer, was coated and evaluated as in example 6, i.e. by means of the coin scratch test and the cross-cut test. On scratching the coated floor with a coin, a strip and flakes of detached coating were formed. According to the cross-cut test, the coating had an adhesion mark 2. This demonstrates the inferiority of the regular preparation procedure and regular product in comparison with the procedure and product of the invention.

### Example 9

### Comparative, Sanding Down to Bare Wood and Building a New Multi Layer Coating

A floor as in example 5, but sized 20 m², was sanded down to bare wood, which took 3 h. The floor was then coated with a base coat (Bona Prime Intense), which took 0.5 h and after 2 h of drying a first layer of top coat (Bona Traffic) was applied. After drying over night, a second layer of top coat (Bona Traffic) was applied. The material and labour cost amounted to about SEK 4700. As is clearly shown, this procedure of refurbishing a floor is considerably more time consuming and costly than the procedure of the invention using the stripping formula of the invention. Furthermore, by the procedure of this example, approximately half of the originally available wear layer of the floor, i.e. the amount of wood, bamboo and/or cork that enables that a totally worn floor is sanded instead of replaced, is removed and thus the floor can only tolerate one such treatment.

1. A method for treating a wooden, bamboo and/or cork floor treated with at least one maintenance material, wherein said maintenance material is an agent applied to a coated floor in order to preserve the properties of the floor, which method comprises
applying a stripping formula on the wooden, bamboo and/or cork floor, wherein the stripping formula comprises at least one of the following: a surface active agent, a swelling agent, a grinding agent and a carrier;
allowing the stripping formula to interact with the at least one maintenance material;
applying mechanical treatment to release the at least one maintenance material; and
removing the at least one maintenance material and the stripping formula.

2. The method according to claim 1, wherein the wooden, bamboo and/or cork floor is coated by an existing coating.

3. The method according to claim 2, wherein the existing coating is substantially preserved after removing the at least one maintenance material and the stripping formula.

4. The method according to claim 1, wherein the stripping formula is a liquid or a slurry such as a paste.

5. The method according to claim 1, wherein the stripping formula comprises at least two of the following: a surface active agent, a swelling agent, a grinding agent and a carrier.

6. The method according to claim 1, wherein the stripping formula comprises at least three of the following: a surface active agent, a swelling agent, a grinding agent and a carrier.

7. The method according to claim 1, wherein the stripping formula comprises a surface active agent, a swelling agent, a grinding agent and a carrier.

8. The method according to claim 1, wherein the surface active agent is selected from the group consisting of nonionic surface active agents such as monoalcohol ethoxylates such as a fatty alcohol ethoxylates, Guerbet alcohol ethoxylates, fatty alcohol propoxylates, alkylphenol ethoxylates, copolymers of ethylene oxide and propylene oxide, and alkyl(poly)glucoside; anionic surface active agents such as soaps, sulfonated derivatives and phosphated derivatives; cationic surface active agents; and amphoteric surface active agents; or any combination or mixture thereof.

9. The method according to claim 1, wherein the swelling agent is selected from the group consisting of alcohols such as butanol, benzyl alcohol, propylene glycol, diethylene glycol, dipropylene glycol, hexylene glycol, glycerol;
esters such as butyl acetate; dibasic esters such as dimethyl succinate, dimethyl glutarate, dimethyl adipate, diisopropyl succinate, and diisopropyl adipate; ketones such as isobutyl methyl ketone; ethers such as alkoxylated alcohols such as methoxyethanol, ethoxyethanol, butoxyethanol, phenoxyethanol, phenoxypropanol, diethyleneglycol monomethyl ether, propylene glycol monomethyl ether, dipropylene glycol monomethyl ether, tripropylene glycol monomethyl ether, dipropylene glycol monobutyl ether, dipropylene glycol monopropyl ether, and dipropyleneglycol dimethyl ether; heterocyclics such as N-methyl-2-pyrrolidone, N-ethyl-2-pyrrolidone, tetrahydrofurane, propylene carbonate and butylene carbonate; hydrocarbons such as terpenes; dimethylformamide and dimethylsulfoxide; or any combination or mixture thereof.

10. The method according to claim 1, wherein the grinding agent is selected from the group consisting of organic grinding agents, such as hard polymer particles, such as polystyrene and poly(methyl methacrylate); amino resins; grinding agents of natural origin, such as grinding agents derived from nut shell; and inorganic grinding agents, such as aluminium oxide, silica, carborundum, boronitride, zirconium carbide, diamond, and quarts mineral; or any combination or mixture thereof.

11. The method according to claim 1, wherein the carrier is water.

12. The method according to claim 1, wherein the stripping formula further comprises at least one additive.

13. The method according to claim 12, wherein the at least one additive is a stabilizing agent, a complexing agent, a pH regulating agent, a colorant, a perfume and/or a preservative.

14. The method according to claim 1, wherein the maintenance material is selected from the group consisting of waxes, hard wax oil, polishes, detergents such as dishwasher detergents and washing detergents, soaps, soft soaps, scouring agents, cleaning agents and/or aqueous solutions of surface active agents; or any combination or mixture thereof.

15. The method according to claim 1, wherein the stripping formula is allowed to interact with the at least one maintenance material for 0.08-60 minutes, such as for 1-30 minutes, such as for 3-5 minutes, before applying the mechanical treatment.

16. The method according to claim 1, wherein the method further comprises cleaning the wooden, bamboo and/or cork floor before and/or after the at least one maintenance material and the stripping formula are removed.

17. The method according to claim 1, wherein the method further comprises coating or recoating of the wooden, bamboo and/or cork floor.
